(19) United States
(12) Patent Application Publication
(10) Pub. No.: US 2007/0289469 A1
(43) Pub. Date: Dec. 20, 2007

(54) Sleeve-Like Cover with a Slit for a Cylinder in a Press

(75) Inventors: Franck Roland, Balagny sur Therain (FR); Alain Blanchard, Gouvieux (FR)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Montataire S.A., Montataire (FR)

(21) Appl. No.: 10/565,792

(22) PCT Filed: Jul. 16, 2004
(86) PCT No.: PCT/EP04/07899

§ 371 Date: Jan. 25, 2006

(30) Foreign Application Priority Data
Jul. 25, 2003 (DE) 103 34 356.3

(51) Int. Cl. B41F 27/12

(52) U.S. Cl. 101/477

(57) ABSTRACT

A sleeve-like cover for a cylinder in a press for holding a plate-like printing form, having a slit which runs substantially parallel to the axis of rotation of the cover, it being possible for edges of a printing form to be fixed in the slit by means of at least one retaining force element. Sleeve-like covers with different external diameters for a cylinder in a press are used in order to vary the printing length of the press.

Priority to German Patent Application No 103 34 356.3, filed Jul. 25, 2004 and incorporated by reference, is claimed hereby.

The invention relates to a sleeve-like cover with slit for a cylinder in a press, for holding a plate-like printing form.

In a press, the circumferential length of the printing form cylinder is a basically limiting parameter for the format or the printing length of products to be produced. In order to achieve flexibility and variability, it is desirable to overcome this limitation in order that a printing length variation or format variation is made possible. From general geometric considerations, it is known that the circumferential length of a cylinder, here the printing form cylinder, is proportional to its radius. In order to carry out a circumferential length variation of a cylinder with a fixed radius on which a printing form can be held in a press, sleeve-like covers of various thickness can advantageously be fitted to the cylinder. With the cover fitted and, consequently, a larger radius, the potential or maximum achievable printing length is then greater or longer than without a cover fitted.

For example, the document U.S. Pat. No. 5,813,336 discloses fitting sleeve-like covers to printing unit cylinders, in particular printing plate cylinders and transfer printing cylinders in a press. Plate-like printing forms can be fixed to sleeve-like covers. The sleeve-like covers described have a recess which runs substantially parallel to the axis of the cover in its edge of a printing form to be fitted can be inserted into the recess and fixed by a printing form fixing element, not specified in more detail.

The object of the present invention is to provide a sleeve-like cover for holding a plate-like printing form, which can be fixed simply and quickly to a printing form cylinder.

According to the invention, this object is achieved by a sleeve-like cover having the features as claimed in claim 1. Advantageous embodiments and further developments of the sleeve-like cover are characterized in the dependent claims.

According to the invention, a sleeve-like cover for a cylinder in a press, for holding a plate-like printing form, has a slit (or a gap or a continuous recess) which runs substantially parallel to the axis of rotation of the cover, in its outer circumferential surface. The slit is designed in such a way that, by means of at least one retaining force element, in particular a spring, edges, the leading edge and the trailing edge, of a printing form can be fixed in the slit. In particular, the edges of the printing form are pressed against walls of the slit. Expressed in other words, each edge of the two edges of the printing form is clamped in between at least one part of the retaining force element and a wall.

On account of the slit introduced into the sleeve-like cover, with an expenditure of force or expenditure on expansion which is lower as compared with a slit-free or continuous cover, slight internal diameter variations of the cover are possible, so that slipping over or pulling over onto a printing form cylinder is made easier or simplified.

press in a straightforward manner with a short changeover time: if sleeve-like covers according to the invention in various formats or with various external diameters but with substantially identical internal diameters are kept in reserve, printing forms of various lengths can be accommodated on a fixed-radius printing form cylinder of a press and used for printing. Expressed in another way, it is possible for sleeve-like covers according to the invention in different formats to be used to change the printing length of a press. Therefore, the use of sleeve-like covers according to the invention, in particular as characterized in this representation, for a cylinder in a press, with different external diameters for the variation of the printing length of the press, is connected with this inventive idea.

The advantages of the invention can be seen in particular in the fact that changeover actions from a first to a second printing length format can already be carried out in parallel in time during the printing operation of the press in the first printing length format. In addition, changing sleeve-like covers which bear printing forms can be carried out in parallel in time. The requisite changeover time can thus be shortened.

Furthermore, mention should be made of the fact that, even given a high speed of revolution of the printing form cylinder with a sleeve-like cover according to the invention fitted and bearing the printing form, the printing form is fixed and stabilized well.

On the sleeve-like cover according to the invention, the at least one retaining force element can be fixed in the slit in the sleeve-like cover. Furthermore or alternatively, the surface into the interior of the sleeve-like cover. Furthermore or alternatively, the slit can be substantially symmetrical in relation to a plane which cuts the slit and in which the axis of symmetry of the sleeve-like cover runs. Additionally or alternatively, the edges of the slit formed with the outer circumferential surface can be rounded off and have a curved contour. With these measures, a beneficial distribution of forces can advantageously be achieved.

The at least one retaining force element can be an elastically deformable spring, a leaf spring, a compression spring or a fluid-pressurized pressure element or tension element. In particular, use can be made of a pair of retaining force elements. In a preferred embodiment, the retaining force element comprises a first and second leaf spring, each one of the leaf springs being designed to press one edge of a printing form in the slit against a wall of the slit.

An advantageous further development of the sleeve-like cover has a layer structure with a number of layers. The layers can be made of different materials with different properties, in particular elasticity properties. It is possible for various polymer materials, such as rubber or polyurethane, or else glass fiber reinforced or plastic fiber reinforced plastics (composite materials) to be used. Furthermore or alternatively, the sleeve-like cover can at least partly have a material which permits elastic deformation of the sleeve-like cover at least in the radial direction, in such a way that the internal diameter and/or the external diameter of the sleeve-like cover can be varied.

In another advantageous and further development, which can be provided additionally or alternatively to that already its inner circumferential surface, in which, when the sleeve-like cover is held on a printing form cylinder, at least one protrusion of the printing form cylinder and/or at least one lever element for producing a tangential tension in the sleeve-like cover can engage. In this way, the cover can be secured and fixed well on the cylinder.

Also connected with the inventive idea is a method of holding a plate-like printing form on a sleeve-like cover, as characterized in this representation. The leading edge of the printing form is inserted into a slit in the sleeve-like cover of the printing form and clamped between a retaining force element and a wall of the slit. The printing form is then wound onto the outer circumferential surface of the sleeve-like cover. Finally, the trailing edge of the printing form is inserted into the slit in the sleeve-like cover of the printing form and clamped between the retaining force element and the wall or another wall of the slit. The method can be carried out outside a press.

The invention can be employed in printing units of sheet-processing presses (sheet-fed press) or in printing units of web-processing presses (web-fed press), in particular offset presses. Typical printing materials are paper, paperboard, board, organic polymer film or fabric or the like. In this case, the press is designed in such a way that it permits the fitting of sleeve-like covers at least to the printing form cylinder: a cylinder journal of the relevant printing form cylinder can be exposed, so that the sleeve-like cover can be pushed or pulled over the printing form cylinder substantially parallel to the printing form cylinder axis. With reference to variable printing length, the axial spacings of the relevant printing form cylinder and of the transfer printing cylinder and reduced, so that a sleeve-like cover held on the printing form cylinder can roll on the circumferential surface of the interacting transfer printing cylinder with a specific contact force. A web-processing printing unit of this type is described in the document U.S. Pat. No. 5,813,336, whose disclosure content is incorporated in this representation by reference.

Further advantages and features as well as advantageous improvements and developments of the invention will be illustrated by using the following figures and their descriptions. In detail:

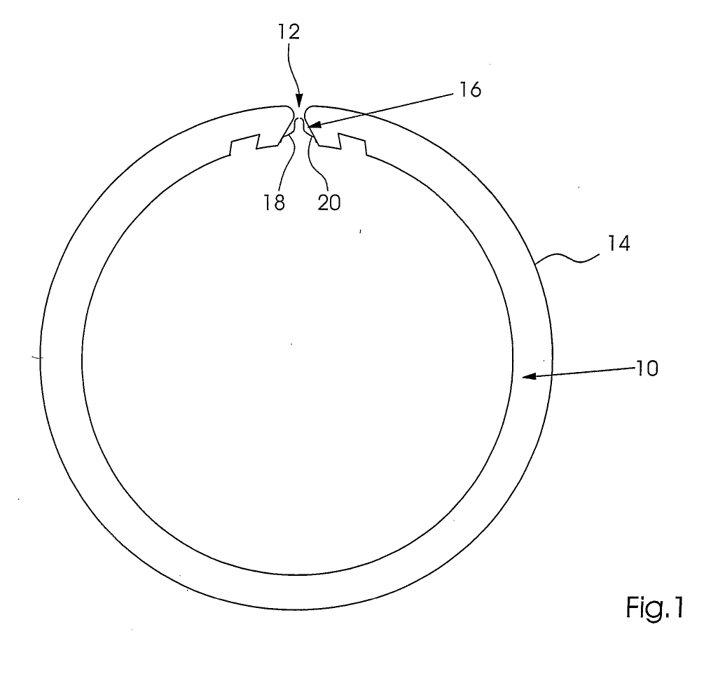

FIG. 1 shows a preferred embodiment of a sleeve-like cover according to the invention,

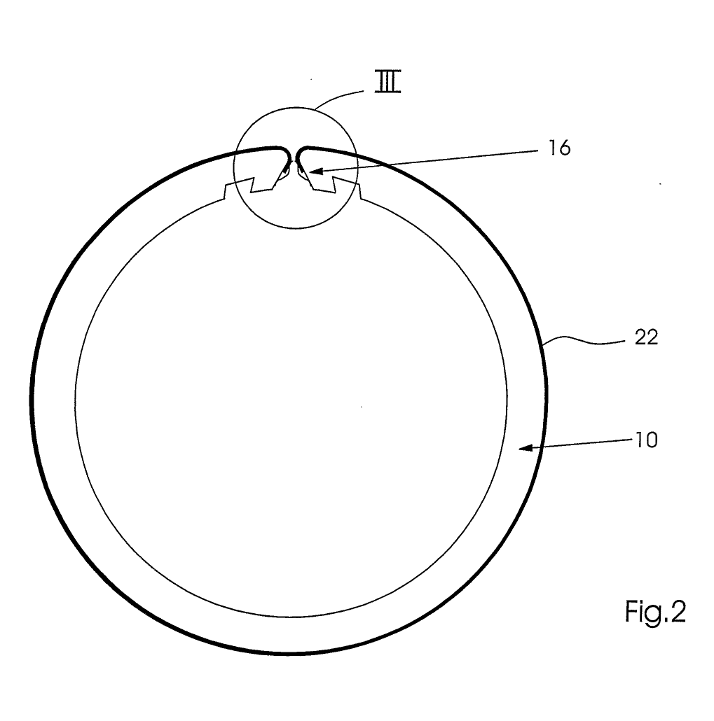

FIG. 2 shows a plate-like printing form, held by the sleeve-like cover according to FIG. 1,

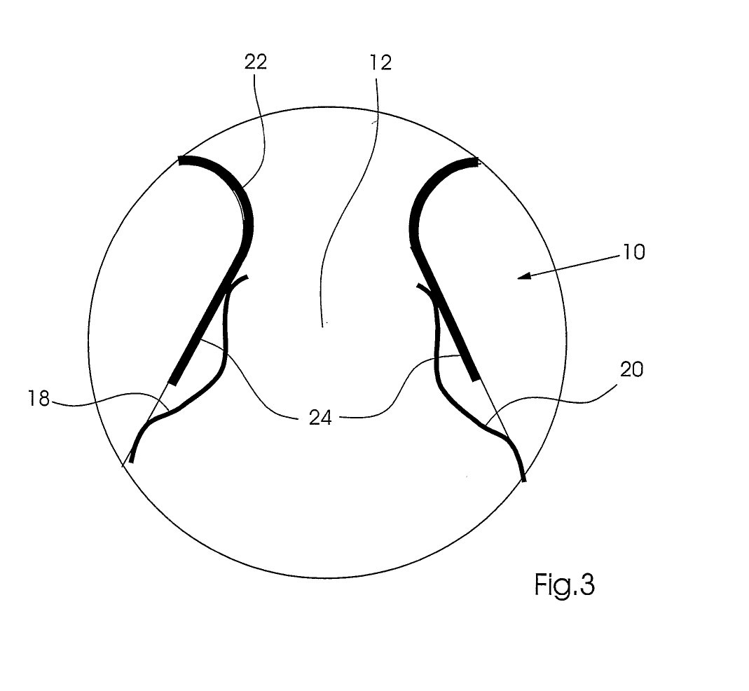

FIG. 3 shows the enlargement of the detail III from FIG. 2,

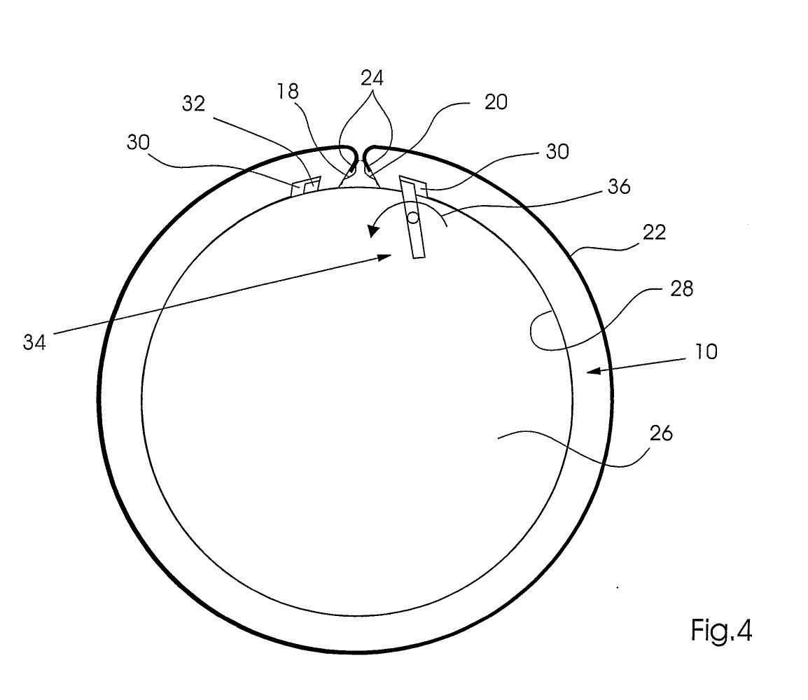

FIG. 4 shows the preferred embodiment of the sleeve-like cover held on a printing form cylinder,

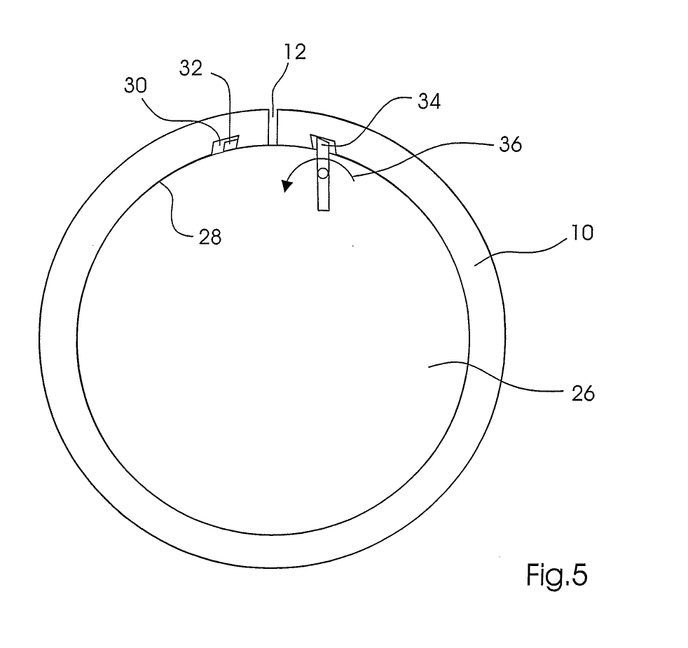

FIG. 5 shows an alternative embodiment of a sleeve-like cover according to the invention,

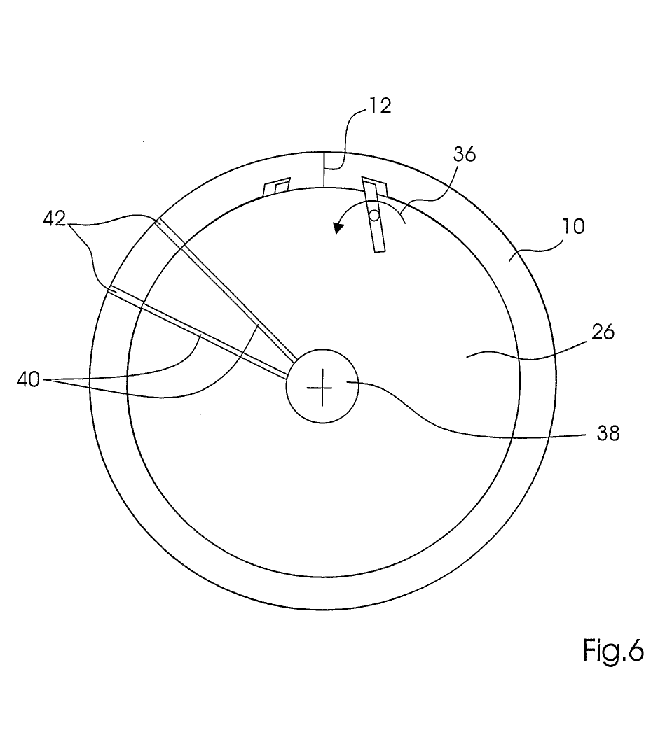

FIG. 6 shows a further alternative embodiment of a sleeve-like cover according to the invention with air outlet ducts, and

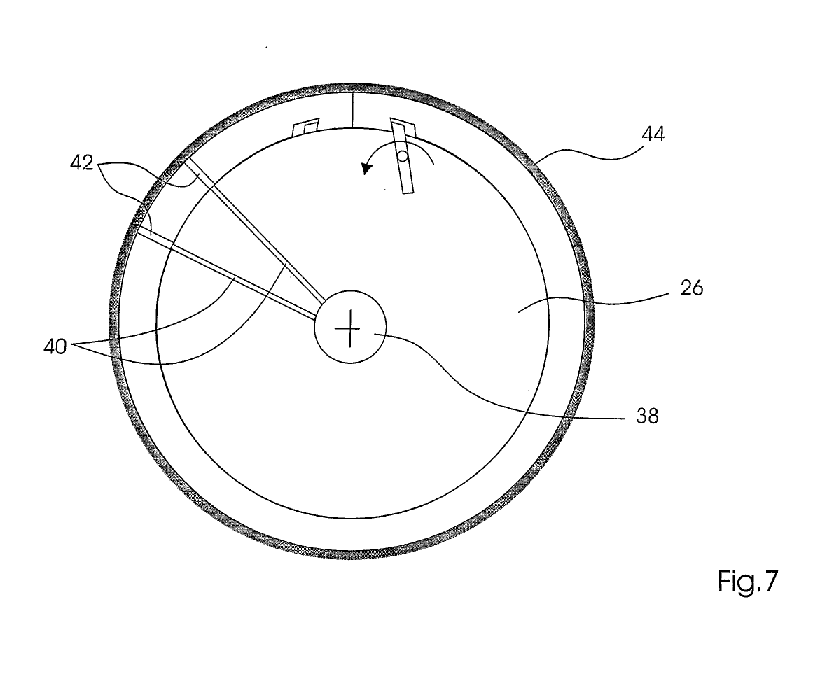

FIG. 7 shows the embodiment according to FIG. 6 with a sleeve-like printing form fitted,

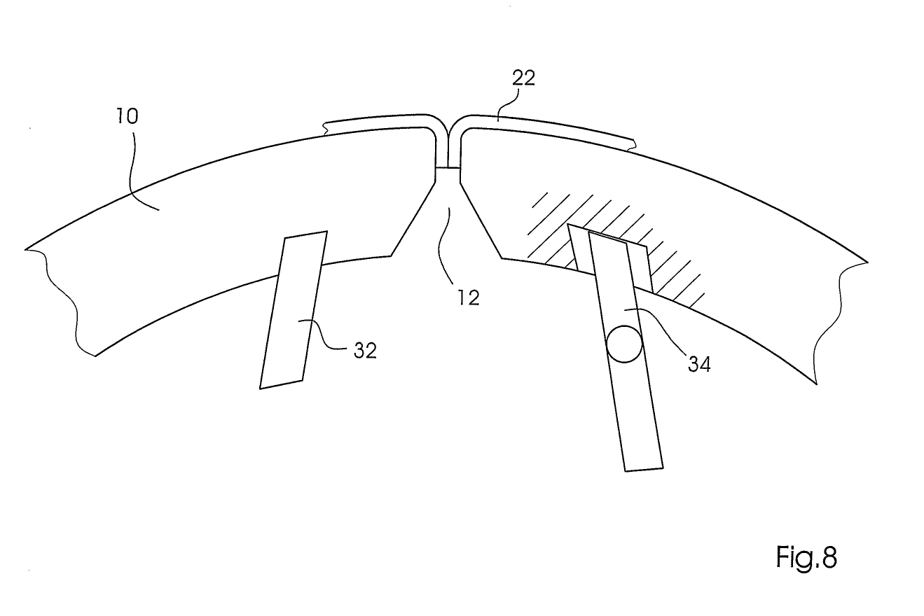

FIG. 8 shows an extract from the embodiment according to FIG. 5 with a plate-like printing form fitted.

A preferred embodiment of a sleeve-like cover 10 according to the invention is to be seen in FIG. 1. A sleeve-like cover 10 (tube-like, pipe-like or hollow cylindrical) has a continuous gap or slit 12 and can be deformed elastically. The sleeve-like cover 10 is made of a material which is flexible or elastic, at least in the radial direction, and in particular consists of a composite material. The slit 12 can widen trapezoidally or prismatically from the outer surface or outer circumferential surface 14 as far as the inner surface or inner circumferential surface 28. The slit 12 is used to hold the bent-down edges 24 (leading edge and trailing edge) of a plate-like printing form 22 (see FIGS. 2 and 3). On the inner circumferential surface 28, it is optionally possible, as shown here in FIG. 1, for the sleeve-like cover 10 to advantageously have at least one, in particular two, recesses 30. The sleeve-like cover 10 can be pushed or pulled over a cylinder, in particular a printing form cylinder, in a press.

In FIG. 2, it is shown that in the slit 12 there is a retaining force element 16, by means of which a plate-like printing form 22 can be fixed to the sleeve-like cover 10: a first spring 18 and a second spring 20 are accommodated or fixed in the slit 12. A plate-like printing form 22 with bent-over edges 24 is fixed in that, by means of the retaining force element 16, more precisely the springs 18, 20, the edges 24, which project into the slit 12 when the plate-like printing form 22 is to be held on the cover 10, are pressed against the walls of the slit 12. The bent-over edges 24 can be hook-like. The plate-like printing form 22 can be fitted, held and drawn on the sleeve-like cover 10 without tension, comprising the sleeve-like cover 10 and the plate-like printing form 22 can be handled together.

In an alternative embodiment of the sleeve-like cover according to the invention, not shown here in figures, the fixing of a plate-like printing form 22 to the cover 10 can be carried out by means of a familiar printing form clamping device as retaining force element 16, which projects over the surface of a printing form cylinder 26 into the slit 12 in the fitted cover 10.

In FIG. 3, the detail III from FIG. 2 is shown enlarged. The slit 12 widens prismatically or trapezoidally with increasing depth from the outer circumferential surface 14 toward the inner circumferential surface 28. In particular, the slit 12 is symmetrical with respect to a plane which cuts the slit and in which the rotational axis of symmetry of the sleeve-like cover 10 lies. In the slit 12, the edges 24 are pressed against the walls of the slit 12, that is to say against the sleeve-like cover 10, by a retaining force element 16 in the form of two individual, also curved, leaf springs 18, 20.

In FIG. 4, the sleeve-like cover 10 with plate-like printing form 22 fitted is shown on a printing form cylinder 26. The internal diameter of the sleeve-like cover 10 is slightly smaller than the diameter of the accommodating printing form cylinder 26. A tangential tension of the sleeve-like cover 10 is achieved by means of a lever element 34: the lever element 34 engages in a recess 30 in the inner circumferential surface 28 of the cover 10 and, when rotated in the direction 36 by means of a rotating and tensioning device, not shown in detail here, acts in such a way that the slit 12 becomes narrower, 12 against which the edges 24 of the printing form 22 are pressed becomes smaller. A protrusion 32 engages in a further recess 30 in the inner circumferential surface 28 of the cover 10. In addition, the fitted plate-like printing plate 22, whose edges 24 are simultaneously fixed to the sleeve-like cover 10 by means of the retaining force element 16, is therefore tensioned in the tangential direction. In the tensioned state, the position of the sleeve-like cover 10 on the printing form cylinder 26 is fixed. At least the further recess 30, in which the protrusion 32 engages, can run in the manner of a groove substantially parallel to the axis of rotation of the cover 10, so that the sleeve-like cover 10 can be removed from the printing form cylinder 26 and fitted to the printing form cylinder 26 in the direction substantially parallel to the axis of rotation of the printing form cylinder 26, it being possible for the protrusion 32 to move in the groove-like further recess 30. For the fitting and removal of a sleeve-like cover 10, the lever element 34 can be sunk below the contour of the printing form cylinder 26. Alternatively, the recess 30 that interacts with the lever element 34 can be designed to extend in the manner of a groove substantially along the axis of rotation.

An alternative embodiment of a sleeve-like cover according to the invention is shown in FIG. 5. Although a sleeve-like cover according to the invention is suitable for holding plate-like printing forms or plate-like rubber blankets, a sleeve-like printing form or a sleeve-like rubber blanket can also be fitted. The sleeve-like cover 10 shown has a slit 12 running substantially radially, whose walls have a shape which match one another, here aligned substantially radially or parallel to one another, in such a way that they can make a form fit. On the inner circumferential surface 28, the sleeve—which a protrusion 32 from the accommodating printing form cylinder 26 can engage. By means of a lever element 34, a tension in the circumferential direction can be produced, until the walls of the slit 12 contact each other with a form fit when the lever element 34 is pivoted in the direction 36 and acts on a recess in the cover 10.

A further alternative embodiment of a sleeve-like cover according to the invention, similar to that of FIG. 5, having air outlet ducts is shown in FIG. 6: the printing form cylinder 26 (also, analogously, a rubber blanket cylinder or transfer printing cylinder) has a central duct 38, running substantially parallel to the axis of rotation of the printing form cylinder 26, for the supply of compressed air, from which there originate a number of air outlet ducts 40, two shown in FIG. 6 here, without restricting a general number. A sleeve-like cover 10 located on the printing form cylinder 26 (also, analogously, a rubber blanket cylinder or transfer printing cylinder) has air ducts 42 which, in the state of the cover 10 in which it is tensioned in the circumferential direction by means of the lever element 34, when the walls of the slit 12 rest on each other with a form fit, are aligned with the air outlet ducts 40 in such a way that the compressed air supplied through the duct 38 can emerge from the air ducts 42 on the surface of the sleeve-like cover 10.

FIG. 7 shows the embodiment according to FIG. 6 with a sleeve-like printing form fitted: a sleeve-like printing form or a sleeve-like rubber blanket can be drawn simply over the sleeve-like cover 10 as a result of the action of an air pad produced on the surface of the cover 10. By means of the radially acting forces of the compressed air escaping from the air ducts 42, an intrinsically relatively stiff sleeve-like blanket or sleeve) can be expanded slightly radially, so that an adequate inner width is produced in order to push the sleeve-like printing form 44 axially over the cylinder or to remove it from the latter in the direction parallel to the axis of rotation, while the inner diameter of the sleeve-like printing form in the radially untensioned state is slightly smaller than the external diameter of the sleeve-like cover 10, so that a firm seat in relation to each other is made possible, avoiding any relative movement of printing form and cover.

FIG. 8 shows a part of the embodiment according to FIG. 5 with a plate-like printing form 22 fitted. In this enlargement of an extract from FIG. 5, it can be seen that, in a special embodiment, the slot 12 can also widen trapezoidally to some extent toward the inside. If the sleeve-like cover 10 is pretensioned in the circumferential direction by means of the lever element 34 and fixing by the protrusion 32, as described in more detail above, then bent-over edges of a plate-like printing form 22 can be clamped in the slit 12, in order that the plate-like printing form 22 is fixed in its position on the sleeve-like cover 10. In an embodiment of this type, the walls of the slit 12 function as a restraining force element for fixing the edges.

While, in the description of FIGS. 5 to 8, reference has been made in particular to fitting sleeve-like printing forms, it should be emphasized again at this point that the sleeve-like covers 10 according to the invention can also be used to hold rubber blankets, in particular sleeve-like rubber blankets. present disclosure of this representation not just to printing form cylinders and printing forms but also to blanket cylinders and rubber blankets, be they plate-like or sleeve-like, and will interpret and understand all the exemplary embodiments in the corresponding way for rubber blankets.

Sleeve-like covers 10 can have different thicknesses and therefore a different circumferential length of the outer surface 14. When sleeve-like covers 10 of different thicknesses are used, the printing length format of the accommodating printing form cylinder can be changed or varied.

In summary, it should be recorded that a plate-like printing form 22 can be fitted to the sleeve-like cover 10 with slit outside the press and before the production run or even during a preceding production run with other printing forms. The group formed by cover and printing form is installed on a printing form cylinder during an interruption in the press operation with the aid of expansion of the cover, made easier by the existing slit, by means of an air pad. When the installation of the cover has been completed, the latter can be tensioned in the tangential direction on the printing form cylinder, so that the cover is fixed or held in its position. A plurality of sleeve-like covers with different external diameters and a plurality of plate-like printing forms with different lengths can be employed on the same printing form cylinder, so that the printing length can be varied.

10 Sleeve-like cover

12 Slit

14 Outer circumferential surface

16 Retaining force element

18 First spring

20 Second spring

22 Plate-like printing form

24 Edge

26 Printing form cylinder

28 Inner circumferential surface

30 Recess

32 Protrusion

34 Lever element

36 Direction

38 Duct

40 Air outlet duct

42 Air duct

44 Sleeve-like printing form

What is claimed is:

1-10. (canceled)

11. A sleeve-like cover for a cylinder in a press, for holding a plate-like printing form comprising:
material having a slit running parallel to an axis of rotation of the cover, edges of a printing form fixable in the slit via at least one retaining force element.

12. The sleeve-like cover as recited in claim 11 further comprising the at least one retaining force element being fixed in the slit.

13. The sleeve-like cover as recited in claim 11 wherein the slit widens trapezoidally from an outer circumferential surface into an interior of the sleeve-like cover or the slit is symmetrical to a plane in which an axis of symmetry of the sleeve-like cover runs.

14. The sleeve-like cover as recited in claim 11 wherein edges of the slit formed with the outer circumferential surface are rounded.

15. The sleeve-like cover as recited in claim 11 further comprising the retaining force element, a first and a second leaf spring for pressing on the edges of the printing form in the slit against a wall of the slit.

16. The sleeve-like cover as recited in claim 11 wherein the material includes a layer structure with a number of layers.

17. The sleeve-like cover as recited in claim 11 wherein the material permits elastic deformation of the sleeve-like cover at least in the radial direction so that an internal diameter or an external diameter of the sleeve-like cover can be varied.

18. The sleeve-like cover as recited in claim 11 wherein the material includes at least one recess in an inner circumferential surface, at least one protrusion or at least one lever element engagable in the recess to produce a tangential tension of the sleeve-like cover.

19. The sleeve-like cover as recited in claim 18 where the at least one recess includes two recesses.

20. A method for varying a printing length of a press comprising exchanging a sleeve-like cover as recited in claim 11 with a further sleeve-like cover of a different external diameter.

21. A method of fitting a plate-like printing form to a sleeve-like cover as recited in claim 10 comprising the steps of:
introducing a leading edge of the edges of printing form into the slit in the sleeve-like cover of the printing form;
winding the printing form onto an outer circumferential surface of the sleeve-like cover; and
introducing a trailing edge of the edges of printing form into the slit in the sleeve-like cover of the printing form,
the leading edge and the trailing edge of the printing form being clamped between the retaining force element and a wall of the slit.
